(19) United States
(12) Patent Application Publication
(10) Pub. No.: US 2014/0158485 A1
(43) Pub. Date: Jun. 12, 2014

(54) SERVICEABLE DRIVE ASSEMBLY AND METHOD

(71) Applicant: CATERPILLAR INC., Peoria, IL (US)

(72) Inventors: Joshua David Nolke, Durham (GB); Ian Macdonald, Hoffman Estates, IL (US)

(73) Assignee: Caterpillar Inc., Peoria, IL (US)

(21) Appl. No.: 13/712,548

(22) Filed: Dec. 12, 2012

(51) Int. Cl. B60T 1/06

(52) U.S. Cl. CPC B60T 1/062
USPC 188/18 A; 74/607; 29/426.1; 29/402.08; 29/402.04

(57) ABSTRACT

A serviceable drive assembly is disclosed. The leg housing assembly may include a flange disposed around an opening at a first end. The leg housing may also include a plurality of brake hub retention tabs extending radially inward from the flange into the opening. A method of servicing an output shaft locating within the leg housing assembly is also disclosed.

### TECHNICAL FIELD

The present disclosure is directed to a serviceable drive assembly and, more particularly, to a leg housing assembly with an associated brake hub retention system.

### BACKGROUND

Machines, including on and off-highway haul and vocational trucks, wheel loaders, motor graders, and other types of heavy equipment generally include an oil-cooled hydraulic braking system. In an oil-cooled hydraulic braking system, also known as a wet brake system, multiple brake disks are placed over a brake hub and wheel axle, and spacer plates are placed between each brake disk. Hydraulic oil runs through the brake system and in between the alternating brake disks and spacer plates. The oil creates a film on the brake disks and spacer plates, helping to prevent direct contact between the compressed rotating surfaces and extend brake life. The hydraulic oil also serves to cool the braking system. Standard brake hubs may trap oil and heat, preventing adequate cooling of their associated components.

Wet brake systems are sealed and enclosed systems that may require the placement of sealing gaskets at interfaces between attached structures that are integral to the formation of the enclosed system. These gaskets typically have to be replaced each time the attached structures are separated to service components of the system adding time and expense servicing the wet brake system and any unnecessary separation of components should be avoided during service.

A serviceable wet brake system is described in U.S. Pat. No. 4,173,269 (“the '269 patent”) of Craig that issued on Nov. 6, 1979. The '269 patent describes a wet brake system that provides a disc pack with a plurality of outwardly projecting tangs that center the brake stack and allow removal of the rotating hub without causing misalignment of the stack.

Although the system of the '269 patent may be capable of providing a level of ease of service, it may still be suboptimal and not address servicing of a wet brake system with a larger cooling oil volume the extends into adjoining structures, such as a leg housing assembly.

The leg housing assembly with an associated brake hub retention system of the present disclosure solves one or more of the problems set forth above and/or other problems of the prior art.

### SUMMARY

One aspect of the present disclosure is directed to a leg housing assembly. The leg housing assembly may include a flange disposed around on opening at a first end of the leg housing. The leg housing assembly may further be provided with a plurality of brake hub retention tabs extending radially inward from the flange into the opening.

Another aspect of the present disclosure is directed to a drive assembly. The drive assembly may include a center housing and a first leg housing assembly connected to an end of the center housing. The leg housing assembly may include a body portion including a first end, a second end and an interior volume. The leg housing assembly may also include a flange disposed around a generally circular opening having a diameter at the first end. The leg housing assembly may further include a plurality of brake hub retention tabs extending radially inward from the flange into the opening. The drive assembly may also include an output shaft at least partially disposed within the center housing and the leg housing assembly. The drive assembly may further include a brake hub disposed around the output shaft and within the center housing. The brake hub may include a cylindrical body portion having a diameter less than the diameter of the leg housing opening. The brake hub may also include a rim extending from an outer edge of the cylindrical body portion. The rim may include a plurality of splines disposed on an outer annular surface of the rim. The brake hub may further include a flange protruding from the cylindrical body portion and configured to engage a first end of the output shaft.

### BRIEF DESCRIPTION OF THE DRAWINGS

FIG. 1 is a pictorial illustration of an exemplary disclosed drive assembly;

FIG. 2 is a cross-sectional illustration of the drive assembly of FIG. 1;

FIG. 3 is an enlarged cross-sectional illustration of a portion of the drive assembly of FIG. 2; and

FIG. 4 is a pictorial illustration of an exemplary disclosed brake hub of FIG. 3.

### DETAILED DESCRIPTION

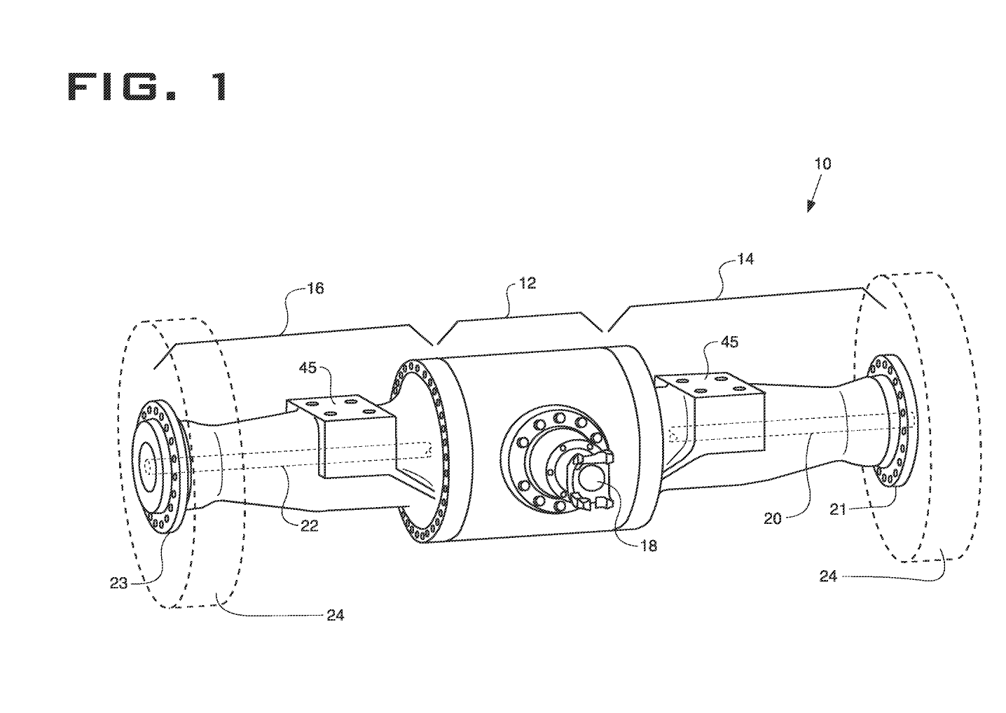

FIG. 1 illustrates an exemplary axle assembly or drive assembly 10. Drive assembly 10 may include a differential assembly 12 and first and second final drive assemblies 14, 16. An input member such as a driveshaft 18 may drivingly connect a power source (e.g., an engine and transmission, both of which are not shown) to differential assembly 12. Two output members such as a first output shaft 20 and a second output shaft 22 may drivingly connect final drive assemblies 14, 16 to traction devices 24 located on opposing sides of a vehicle supporting the same through output assemblies 21, 23. Traction devices 24 may embody wheels, tracks or any other alternative known to those of ordinary skill in the art. Final drive assemblies 14, 16, may be drivingly coupled to differential assembly 12 such that a rotation of driveshaft 18 results in a corresponding rotation of output shafts 20, 22 to output assemblies 21, 23 and rotation of traction devices 24.

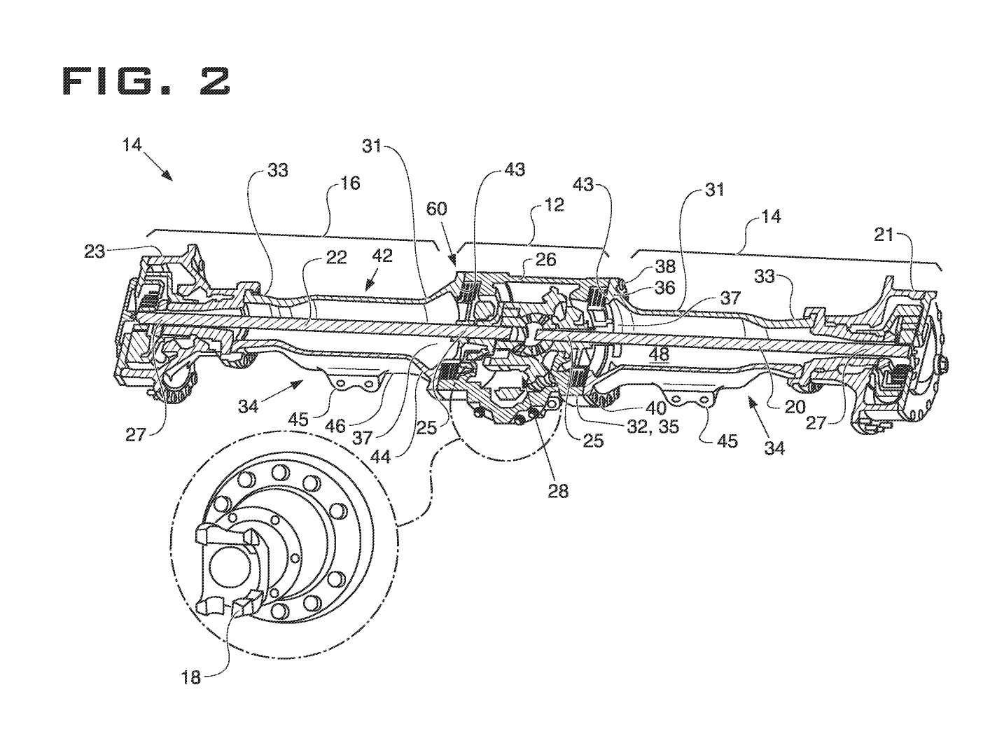

As illustrated in FIG. 2, differential assembly 12 may include a center housing 26 and a differential gear arrangement 28 supported within center housing 26. Center housing 26 may be a generally cylindrical housing having an axial direction substantially aligned with output shafts 20, 22. Driveshaft 18 may extend through a side of center housing 26 to engage and rotationally drive differential gear arrangement 28. In turn, differential gear arrangement 28 may operatively engage and transfer the input rotation of driveshaft 18 to output shafts 20, 22. At each opposing end of center housing 26, an end face 32 may be located to engage and seal against a leg housing assembly 34 of final drive assemblies 14, 16 (i.e., final drive assemblies 14 and 16 may have associated leg housing assemblies 34 that are substantially identical to each other). Specifically, end face 32 of center housing 26 may abut an end face 35 of each leg housing 34 at a first end 31. A sealing element such as, for example, a gasket (not shown) may be inserted between end faces 32 and 35 of center and leg housings 26, 34, if desired, to provide fluid sealing at that interface. End face 35 may be part of a flange 36 extending from the leg housing assembly 34.

Leg housing assembly 34 of each final drive assembly 14, 16 may enclose and support the output shaft 20, 22. Leg housing assembly 34 may also support the output assembly 21, 23 at a second end 33. The output assembly 21, 23 may include, for example, a planetary gear arrangement to transmit rotation of the output shaft 20, 22 to the traction device 24. Leg housing 34 may be connected to center housing 26 by way of, for example, threaded fasteners 38 located around an outer rim 40 of flange 36. The fasteners 38 may be inserted through bores 41 provided in the outer rim 40 of the flange 36. Leg housing assembly 34 may include a body portion 42 that is integral with flange 36. Body portion 42 may include a conical portion 44 and a cylindrical portion 46. The conical portion 44 is located proximal to the first end 21 and the cylindrical portion 46 is located proximal to the second end 33. Conical portion 44 and cylindrical portion 46 may define an interior volume 48 of leg housing 34. The flange 36 surrounds an opening 37 at the first end 31 of the leg housing 34. The opening 37 is generally circular in shape and has a diameter D₁.

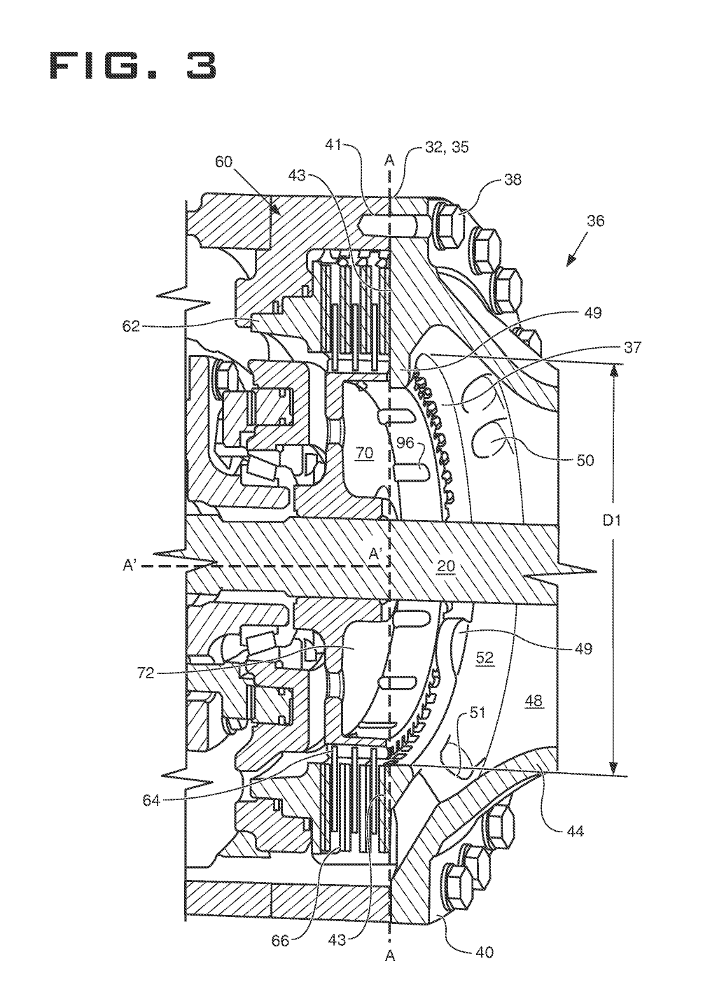

Referring to FIG. 3, flange 36 of the leg housing assembly 34 may include a plurality of brake hub retention tabs 49. The brake hub retention tabs 49 are disposed around the flange 36 and extend into the opening 37. The tabs 49 are arranged such that they extend radially inward from the flange 36 and into the diameter D1 of the opening 37. In an exemplary embodiment, the leg housing 34 has 3 to 10 retention tabs 49, preferably 3 to 5 retention tabs 49. The retention tabs 49 may be provided such that they are evenly spaced around the flange 36 of the leg housing assembly 34.

The flange 36 of the leg housing assembly 34 may also be provided with a brake contact surface 43. The brake contact surface 43 functions as a bearing surface against which the brake stack is compressed in order effect braking of the drive. The brake contact surface 43 will be discussed further herein in relation to the functioning of the brake system. Moreover, leg housing assembly 34 may be provided with mounting surfaces 45 on the exterior of the leg housing. The mounting surfaces 45 can be utilized to mount the drive assembly 10 beneath a machine and/or as a mounting surface for a suspension system between the drive assembly and the machine as is customary.

In an exemplary embodiment, the leg housing 34 further includes a plurality of conduits 50 that extend from end face 35 toward interior volume 48 of leg housing 34 to allow fluid to circulate about the brake discs, which enhances cooling of the discs. Conduits 50 may terminate at a beveled annular surface 52 within interior volume 48. In one exemplary embodiment, a pair of conduits 50 are disposed at an assembled two o'clock position of flange 36 (as viewed from an axial end of leg housing 34). In another exemplary embodiment, a pair of conduits 50 may be disposed at an assembled ten o'clock position on mounting flange 36. That is, two pairs of conduits 50 may be symmetrically arranged with respect to reference axis A-A, with one pair of conduits 50 being disposed approximately at the assembled two o'clock position and the remaining pair of conduits 50 approximately disposed at the assembled ten o'clock position. An additional conduit 51 may be disposed at an assembled gravitational lower half of flange 36. It is further contemplated that another suitable number of conduits 51 may be disposed at an assembled lower half of mounting flange 36. In one exemplary arrangement, two conduits 51 are included and are symmetrically arranged with respect to reference axis A-A, although another suitable arrangement may alternatively be utilized.

Referring to both FIGS. 2 and 3, drive assembly 10 may be equipped with an internal braking system 60 (i.e., braking system 60 may be at least partially enclosed by center housing 26 and leg housing 34) configured to selectively retard the rotation of output shafts 20, 22. Braking system 60 may include an actuator 62, one or more brake disks 64, and one or more spacer plates 66. Brake disks 64 may be splined on to a brake hub 70, and spacer plates 66 may be splined on to leg housing 34. That is, brake disks 64 may be connected to rotate with output shafts 20, 22 via brake hub 70 that is splined on to a first end 25 of output shafts 20, 22 such that, when actuator 62 is acted on by pressurized fluid, brake disks 64 may be sandwiched between alternating spacer plates 66 and compressed against brake contact surface 43 of the leg housing 34, creating friction that slows the rotation of output shafts 20, 22.

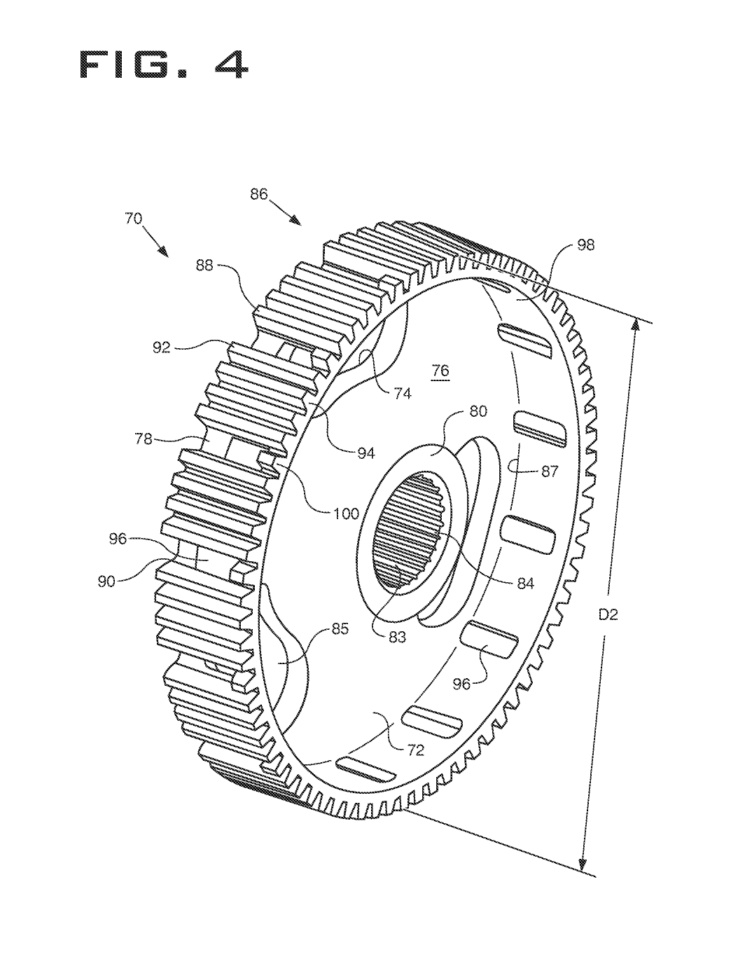

Referring to FIGS. 3-4, brake hub 70 may have a cylindrical body portion 72 with a first end 74, a second end 76, and an outer edge 78. A flange 80 may be disposed at a geometric center of cylindrical body portion 72, and extend outward from first end 74 of cylindrical body portion 72. Flange 80 may also extend from second end 76 of cylindrical body portion 72. Flange 80 may enclose a center aperture 83. The center aperture may be provided with a plurality of hub mounting splines 84 for rotationally fixing the brake hub 70 to an output shaft 20,22.

In an exemplary embodiment, brake hub 70 may also include axial apertures 85 formed in cylindrical body portion 72. Apertures 85 may be kidney-shaped and evenly spaced, although other suitable shapes and spacing may alternatively be utilized. In one exemplary embodiment, brake hub 70 includes three kidney-shaped apertures 85 spaced about 120° from each other to ensure balanced rotation of brake hub 70 and access for fluid to pass through brake hub 70.

Brake hub 70 may also include an outer rim 86 that extends from outer edge 78 in a second direction. Cylindrical body portion 72 and outer rim 86 may be generally perpendicular surfaces that meet at a junction 87. A plurality of splines 88 may be disposed on an outer annular surface 90 of outer rim 86 and extend in the second direction from a first end 92 to a second end 94 of outer rim 86. Outer rim 86 may include a plurality of radial apertures 96 that extend from an inner annular surface 98 through outer annular surface 90. An equal number of splines 88 may be disposed between each aperture 96. Apertures 96 may also extend in the second direction, from junction 87 toward second end 94 of outer rim 86. Apertures 96 may extend only partially along outer rim 86, terminating at partial splines 100. Splines 100 may be disposed along outer rim 86, extending from an end of an aperture 96 toward second end 94 of outer rim 86.

The brake hub 70 including the radial extent of the splines 88 provide the brake hub with a diameter D₂. The brake hub diameter D2 is generally less than the diameter D1 of the leg housing opening 37. By having the diameter D1 of the leg housing opening 37 being greater than the diameter D2 of the brake hub 70, the maximum contact and flow of cooling oil to the brake hub 70 is ensured.

### INDUSTRIAL APPLICABILITY

The disclosed brake hub may be applicable to any brake system where cooling and longevity of brake disks are an issue. Improved cooling and lubrication of wet brake assemblies may by achieved by using centrifugal force to direct oil through radially located apertures. The rotating components of the disclosed braking system may have an extended useful life because of reduced friction between rotating components. Cooling of braking system 60 will now be described.

Referring to FIG. 3, when a braking event of drive assembly 10 is desired by an operator, the plurality of brake disks 64 may be pushed together by actuator 62, resisting the rotation of output shafts 20 and 22. This braking event may generate friction and heat. To reduce friction and to cool brake disks 64, center housing 26 may be filled with oil up to a fill line A′-A′. Fill line A′-A′ may be located approximately at an assembled gravitational halfway point within center housing 26 (i.e., below conduits 50). While brake hub 70 is rotated in either a forward or reverse direction, centrifugal forces generated by this rotation may direct oil radially outward through apertures 96 and into braking system 60. The oil may then exit braking system 60 and center housing 26 via conduits 50 and 51, carrying heat away from braking system 60. The location of conduits 50 at the assembled two o'clock and ten o'clock positions may facilitate oil flow through braking system 60 during both forward and reverse rotation of brake hub 70. That is, during forward rotation, more oil may flow through the two o'clock conduit, and during reverse rotation, more oil may flow through the ten o'clock conduit.

In one exemplary embodiment, drive assembly 10 may have an oil flow ratio of approximately 0.8-1.2. The oil flow ratio may be defined as the total flow area of apertures 96 compared with the total flow area of conduits 50 and 51. When drive assembly 10 is designed to have an oil flow ratio of approximately 0.8-1.2, a low or zero pressure change may be achieved across drive assembly 10. This ratio may increase an amount of time that oil spends within brake system 60, while simultaneously generating little pressure head in conduits 50 and/or 51. Increased pressure at conduits 50 and/or 51 could trap oil within brake system 60 and increase shearing drag losses.

Brake hub 70 may provide improved oil flow and lubrication in braking system 60 by utilizing the centrifugal forces generated during rotation of brake hub 70. Operating costs may be reduced because less oil may be required to lubricate and cool braking system 60. The disclosed brake hub may provide a simple and effective mechanism for cooling a wet brake assembly, and help extend brake disk, spacer, and/or brake hub life by reducing friction and wear of rotating components.

In an exemplary embodiment, the present disclosure provides a method by which to service the output shaft 20, 22 without having to disassemble leg housing 34 from the center housing 12. Having to disassemble the leg housing 34 from the center housing 12 can be a time consuming process that increases downtime for the machine to which the drive assembly 10 is attached.

The method, as described herein relates to a system utilizing the brake hub 70 and leg housing 34 including brake hub retention tabs 49 as described above. The method includes a first step of removing any output assembly 21, 23 associated with the second end 33 of the leg housing 34. This may include removing any traction device 24 that may be associated with the output assembly 21, 23 that would inhibit removal of the output assembly. Additionally, if necessary, some or all of the oil of the wet brake system may need to be drained prior to removal of the output assembly 21, 23. However, due to the shaping of the leg housing 34 and that the leg housing does not need to be removed in this method, gravitational low points in the system provide points for oil to rest such that a complete draining of the system is not required. By removing the output assembly 21, 23, second end 27 of output shaft 20, 22 which transmits rotation to the output assembly 21, 23 is exposed.

The method includes a step of withdrawing or pulling the second end 27 of the output shaft 20, 22 from the second end 33 of the leg housing 34. As the leg housing assembly 34 is for the most part hollow, the output shaft 20, 22 can be withdrawn from the leg housing 34 without further modification once the output assembly 21, 23 is removed.

The method also includes a step of retaining the brake hub 70 within the drive assembly 10 by contacting the brake hub 70 against the brake hub retention tabs 49 as the output shaft 20, 22 is pulled from the drive assembly 10 so that the output shaft 20, 22 may be serviced. Due to the sizing of the opening 37 of the leg housing 34 relative to the brake hub 70 for the reasons discussed above, if the output shaft 20, 22 were to be removed without the presence of the retention tabs 49, the frictional contact of the hub mounting splines 84 of the brake hub 70 would tend to keep the hub 70 with the output shaft 20, 22. If the hub 70 passed through the opening 37 of the leg housing. The stack of brake disks 64 splined to the hub 70 would fall off of the hub as they pressed against the spacer plates 66 and the brake contact surface 43 of the leg housing assembly 34. This would then require the leg housing assembly 34 to be removed from the drive assembly 10. By providing the brake hub retention tabs 49, the hub 70 is retained in place as the output shaft 20, 22 is removed and the brake disks 64 are retained on the hub, thereby imparting benefit to this method.

The method may further include servicing the output shaft 20, 22. The servicing step may include repairing any damage or replacing the output shaft 20,22.

Once the output shaft 20, 22 has been serviced, the first end 25 of the output shaft is inserted/pushed into the second end 33 of the leg housing 34. The output shaft 20, 22 is advanced through the leg housing 34 until the output shaft 20, 22 is brought into contact with the brake hub 70.

The method may further include a step of engaging the first end 25 of the output shaft 20, 22 with the brake hub flange 80. The step of engaging may include aligning the hub mounting splines 84 of the brake hub flange 80 with splines on the first end 25 of the output shaft 20, 22 such that the brake hub 70 and output shaft 20, 22 are rotationally fixed to on another. A further step may include then reattaching the output assembly 21, 23 to the second end 33 of the leg housing assembly 34.

It will be apparent to those skilled in the art that various modifications and variations can be made to the disclosed brake hub without departing from the scope of the disclosure. Other embodiments of the brake hub will be apparent to those skilled in the art from consideration of the specification and practice of the brake hub disclosed herein. It is intended that the specification and examples be considered as exemplary only, with a true scope of the disclosure being indicated by the following claims and their equivalents.

What is claimed is:

1. A leg housing assembly, comprising:
a flange disposed around an opening at a first end; and
a plurality of brake hub retention tabs extending radially inward from the flange into the opening.

2. The leg housing assembly of claim 1, wherein the leg housing assembly further comprises a body portion including the first end, a second end opposite the first end, and an interior volume.

2. The leg housing assembly of claim 1, wherein the plurality of brake retention tabs are evenly spaced around the flange.

3. The leg housing assembly of claim 1, wherein the leg housing has 3 to 5 retention tabs.

4. The leg housing assembly of claim 1, further comprising an outer rim located around the flange, the outer rim including a plurality of bores for receiving fasteners to connect the leg housing assembly to a center housing.

5. The leg housing assembly of claim 1 wherein the body portion comprises a conical portion and a cylindrical portion defining the interior volume of the leg housing assembly.

6. The leg housing assembly of claim 5 wherein the conical portion is located proximal to the first end and the cylindrical portion is located proximal to the second end.

7. The leg housing assembly of claim 1 wherein the flange including a brake contact surface.

8. The leg housing assembly of claim 1 wherein the opening is circular in shape.

9. The leg housing assembly of claim 1 further comprising a first conduit extending from an outer surface of the flange toward an interior volume of the body portion, the first conduit disposed approximately at an assembled two o'clock position of the flange;
a second conduit extending from the outer surface of the flange toward the interior volume of the body portion, the second conduit disposed approximately at an assembled ten o'clock position of the flange; and
a third conduit formed in an assembled gravitational lower half of the flange.

10. The leg housing assembly of claim 1, wherein:
the first conduit is one of a pair of conduits disposed approximately at the assembled two o'clock position of the flange; and
the second conduit is one of a pair of conduits disposed approximately at the assembled ten o'clock position of the flange.

11. The leg housing assembly of claim 1, wherein the third conduit is one of a pair of conduits formed in the assembled gravitational lower half of the flange.

12. A drive assembly, comprising:
a center housing;
a first leg housing assembly connected to an end of the center housing, the leg housing assembly including:
a body portion including a first end, a second end and an interior volume; and
a flange disposed around a generally circular opening having a diameter at the first end; and
a plurality of brake hub retention tabs extending radially inward from the flange into the opening;
an output shaft at least partially disposed within the center housing and the leg housing;
a brake hub disposed around the output shaft and within the center housing, the brake hub including a cylindrical body portion having a diameter less than the diameter of the leg housing opening and configured to engage a first end of the output shaft.

13. The drive assembly of claim 12 further including a second leg housing assembly connected to the center housing at an end opposite of the first leg housing assembly, the second leg housing assembly being substantially identical to the first leg housing assembly.

14. The drive assembly of claim 12 wherein the plurality of brake retention tabs are evenly spaced around the flange.

15. The drive assembly of claim 12, wherein the leg housing assembly has 3 to 5 retention tabs.

16. The drive assembly of claim 12, further comprising an outer rim located around the flange, the outer rim including a plurality of bores for receiving fasteners to connect the leg housing assembly to a center housing.

17. The drive assembly of claim 12, wherein the leg housing assembly further comprises:
a first conduit extending from an outer surface of the flange toward an interior volume of the body portion, the first conduit disposed approximately at an assembled two o'clock position of the flange;
a second conduit extending from the outer surface of the flange toward the interior volume of the body portion, the second conduit disposed approximately at an assembled ten o'clock position of the flange; and
a third conduit formed in an assembled gravitational lower half of the flange.

18. The drive assembly of claim 17, wherein:
the first conduit is one of a pair of conduits disposed approximately at the assembled two o'clock position of the flange;
the second conduit is one of a pair of conduits disposed approximately at the assembled ten o'clock position of the flange; and
the third conduit is one of a pair of conduits formed in the assembled gravitational lower half of the flange.

19. A method of servicing the output shaft associated with the drive assembly of claim 12, the method comprising:
removing an output assembly associated with the second end of the leg housing assembly to expose a second end of the output shaft;
withdrawing the second end of the output shaft from the second end of the leg housing assembly;
retaining the brake hub within the drive assembly by contacting the brake hub against the brake hub retention tabs as the output shaft is pulled from the drive assembly so that the output shaft may be serviced.

20. The method of claim 19 wherein the method further comprises:
servicing the output shaft by repairing or replacing the output shaft;
inserting the first end of the output shaft into the second end of the leg housing assembly;
engaging the first end of the output shaft with the brake hub.
